(19) United States
(12) Patent Application Publication
(10) Pub. No.: US 2006/0275201 A1
(43) Pub. Date: Dec. 7, 2006

(54) Production of perovskite particles

(76) Inventors: Markus Niederberger, Potsdam (DE); Markus Antonietti, Berholz-Rehbrucke (DE)

Correspondence Address: Millen, White, Zelano & Branigan, Arlington Courthouse Plaza 1, 2200 Clarendon Boulevard, Suite 1400, Arlington, VA, 22201, US

(21) Appl. No.: 10/568,531

(22) PCT Filed: Aug. 19, 2004
(86) PCT No.: PCT/EP04/09313

§ 371 Date: Feb. 17, 2006

(30) Foreign Application Priority Data
Aug. 21, 2003 (DE) 103 38 465.0

(51) Int. Cl. C01B 13/00

(52) U.S. Cl. 423/593.1; 423/594.15; 423/594.16; 423/598

(57) ABSTRACT

The invention relates to a method for producing high-purity and highly crystalline perovskite particles and to perovskite particles produced by said method.

The present invention relates to a method for producing perovskite particles having high crystallinity and high purity and to perovskite particles obtainable by the method.

The perovskite group of substances, a special group of mixed metal oxides, has unusual chemical and physical properties, for example catalytic, ferroelectric, pyroelectric, piezoelectric and dielectric behavior. As a result of these properties, perovskites are widely used, for example in piezoelectric layers and high-performance capacitors, high-temperature membranes for fuel cells and high-temperature conductors and in the areas of ferroelectricity, spin electronics, colossal magnetic resistance and nonlinear optical properties.

Since the properties of the perovskite depend substantially on the crystal chemistry, the production of pure, stoichiometric, homogeneous and crystalline perovskite materials having regulated crystallite sizes is of considerable scientific and technological interest. Particularly for the production of thin layers or ceramics, pure nanoscale powders are desired. It has been found that the quality of a ceramic layer improves with decreasing particle size of the starting materials used for its production, at the same time the required sintering temperatures decreasing and the processing conditions thus becoming more advantageous. Perovskites having small crystallite sizes are also of considerable interest for the formation of fine-particled ceramics by sintering methods.

A very thoroughly investigated perovskite material is barium titanate. Barium titanate has a high dielectric constant and ferroelectric properties, which are of major importance for use in electronic and optical apparatuses. BaTiO₃ exists in various crystallographic modifications, the tetragonal and cubic polymorphisms having been investigated most thoroughly. In the production of multilayer capacitors, a decisive precondition is that the BaTiO₃ powder can be processed easily to give thin films. It is therefore desirable to provide BaTiO₃ having small crystallite sizes, high purity and homogeneous composition.

In view of the importance of perovskites, it is not surprising that in the past many attempts were made to synthesize perovskite materials. For example, attempts were made to produce crystalline perovskites by sol-gel methods (Special Issue on “Sol-Gel-Processing of Ferroelectric Materials”, J. Sol-Gel Sci. Tech. 1999, 16, No. 1-2). In particular, sol-gel methods using titanium alkoxides and barium salts have been used, but the addition of ligands and other organic additives as complexing agents or stabilizers for controlling the particle size and for maintaining the particulate stability and for preventing particle agglomeration is often required in these methods (O'Brien et al., J. Am. Chem. Soc. 2001, 123, 12085-12086).

Another method known in the prior art is the hydrothermal treatment of titanium compounds, such as, for example, titanium alkoxide, titanium oxide and titanium oxide gels, in the presence of barium salts in a strongly alkaline solution (Clark et al., J. Mater. Chem. 1999, 9, 83-91; Dutta and Gregg, Chem. Mater. 1992, 843-846 and Walton et al., J. Am. Chem. Soc. 2001, 123, 12547-12555). However, the particle sizes of the perovskites produced by these methods are undesirably large.

In most of the methods known in the prior art for producing perovskite materials, perovskite particles having a size in the range from a few hundred to about 50 nm are formed. The properties of perovskites, for example the ferroelectricity, depend substantially on the particle size. Particles having a size in the so-called critical size range of about 10-20 nm are therefore of particular interest since such particles no longer have ferroelectric behavior. However, the prior art does not describe any synthesis methods by means of which perovskite particles having this desired size can be produced in high purity and satisfactory yield.

It is therefore an object of the present invention to provide a simple and efficient method for producing perovskite particles having a size of less than about 50 nm. A further object of the present invention is the provision of a method for producing perovskite particles, wherein the addition of ligands and other organic additives for controlling the particle size and for maintaining the particle stability is not required. Yet another object of the present invention is the provision of a halogen-free method for producing perovskites. A further object of the present invention is to provide a method by means of which perovskite particles can be produced in high purity and with high yields.

This object was achieved, according to the invention, by a method for producing perovskite particles of the formula ABO₃,
wherein A is a metal of lower valency or a mixture of metals of lower valency,
wherein B is a metal of high valency or a mixture of metals of higher valency,
   characterized by the steps
(a) dissolution of the first metal of the mixture of metals A in an anhydrous solvent or solvent mixture and
(b) reaction of the solution of (a) with an alkoxide of the second metal or of the mixture of metals (B) of the formula B(OR)ₓ and/or B(OR)ₓ₋₂, wherein x is the valency of the metal B and R is a linear or branched alkyl radical having 1 to 30 carbon atoms.

By means of the method according to the invention, perovskite particles having high crystallinity and high purity can be produced by means of a simple synthesis. The desired perovskite material can advantageously be produced in high yields and high purity even without using additional ligands or organic additives. A further advantage of the method according to the invention is that neither water nor acids, bases or opposite ions are used and the product is thus obtained in pure form as a colloidal sol. A further washing step is therefore not required. The solvents used in the method can be easily removed, for example by decomposition or calcination during the formation of a ceramic body.

Perovskite particles of the formula ABO₃ can be produced using the method according to the invention. The term “perovskite” in the context of the present invention includes materials having a perovskite structure or related structure. In the formula ABO₃, A is a metal of lower valency or the mixture of metals of lower valency. The metal or the metals A are preferably alkali metals, alkaline earth metals and/or transition elements. They are preferably monovalent or divalent metals. In a particularly preferred embodiment, the metal or the mixture of metals A is selected from the group consisting of lithium, potassium, calcium, strontium and barium. The use of strontium and barium is most preferred.

In the formula ABO₃, B is a metal of high valency or the mixture of metals of higher valency, in particular selected from the group consisting of the transition elements and metals of groups III and IV. In a preferred embodiment, the metal or metals B are selected from the group consisting of the tetravalent or pentavalent metals.

Preferred metals B are niobium, zirconium, tin and titanium. Titanium is particularly preferred as the metal B.

Specific examples of compounds produced by the method according to the invention are BaTiO₃, SrTiO₃, LiNbO₃ and BaZrO₃.

In the method according to the invention for producing perovskite particles of the structure ABO₃, the first metal is dissolved in an anhydrous solvent in a first step (a). Any desired organic solvent which is obtainable in anhydrous form and is suitable for dissolving the metal may be used. Preferred solvents are halogen-free solvents e.g. alcohols, ketones, aldehydes and mixtures of these solvents. Alcohols and mixtures of alcohols with ketones and/or aldehydes are particularly preferred. In the context of this invention, the term “anhydrous” describes a proportion of water of not more than about 5% by weight, preferably not more than about 1% by weight, more preferably not more than about 0.1% by weight and most preferably 0% by weight of water. An alcohol having sterically stabilizing properties is preferably used. Examples of suitable sterically stabilizing alcohols are alcohols having 4 or more C atoms, e.g. (+)-butanol and similar systems. Benzyl alcohol is particularly preferably used as an alcohol in the method according to the invention. In a preferred embodiment, halogen-free alcohols are furthermore used. Examples of preferred ketones and aldehydes are acetone, methyl ethyl ketone, benzophenone and benzaldehyde.

Depending on the solution behavior of the metal A in the solvent or solvent mixture used, step (a) of the method according to the invention can be carried out at room temperature or at a slightly elevated temperature, for example about 50-100° C. If strongly electropositive elements, such as, for example, alkali metals or alkaline earth metals, are used as first metal A, these react directly with alcohols with liberation of hydrogen and formation of the desired alkoxides. With the use of alkaline earth metals as the first metal A, insoluble bivalent alkoxides may occur, so that the solution formed may be cloudy. If appropriate, a purification step, such as, for example, centrifuging, may be carried out after step (a) in order to remove undissolved substances.

In step (b) of the method according to the invention, the solution obtained in step (a) is reacted with an alkoxide of a second metal or of the mixture of metals B having the formula B(OR)ₓ and/or B(OR)ₓ₋₂, x being the valency of the metal B. R is a linear or branched alkyl radical having 1-30 carbon atoms, in particular having 1-8 carbon atoms, particularly preferably having 1-5 carbon atoms. R is preferably an isopropyl radical. In a preferred embodiment, R is furthermore a halogen-free compound.

The alkoxide having the formula B(OR)ₓ is titanium isopropoxide in a particularly preferred embodiment.

Step (b) of the method according to the invention is preferably carried out at an elevated temperature, for example at a temperature of about 100-300° C., preferably of about 180-230° C., particularly preferably of about 190-220° C. The duration of the reaction can readily be established by the person skilled in the art depending on the metals A and B used; in particular, the duration of the reaction is more than about 12 hours, more preferably more than about 24 hours and most preferably about 48 hours.

The reaction of the solution of a metal or of a mixture of metals A with an alkoxide of a second metal or of a mixture of metals B in step (b) of the method according to the invention can, if appropriate, be effected under superatmospheric pressure, preferably a pressure of not more than 10 bar, for example in an autoclave. In this case, particularly preferred reaction conditions are a duration of the reaction of about 48 hours and a reaction temperature of about 200° C.

In a preferred embodiment of the method according to the invention, step (b) is carried out in an excess of solvent (mixture), for example of the alcohol. The excess of the solvent (mixture), for example of the alcohol, is preferably 10-100-fold.

The molar ratio of metal A to metal B used in the method according to the invention corresponds in particular approximately to the ratio of metal A to metal B in the desired perovskite product. A preferred molar ratio A:B is, for example, about 1:1.

The method according to the invention is therefore a simple method for producing perovskite particles. Advantageously, the starting substances are commercially available so that a complicated synthesis of precursor substances is not required. The perovskite particles produced by the method according to the invention have high crystallinity. By means of the method according to the invention, it is thus possible to produce perovskite particles having a diameter <50 nm, for example having a mean particle size of from about 2 to about 20 nm, preferably from about 5 to about 15 nm and particularly preferably from about 5 to about 10 nm. The production method according to the invention therefore permits the provision of particularly finely divided crystalline perovskites which are desired, for example, for processing in ceramics or for use for further technological and scientific purposes.

Since neither water nor halides are used for the production method, it is possible to produce perovskite particles which have high purity. Contamination with inorganic substances such as, for example, halides and alkali metal ions, which are difficult to remove, is avoided by the method according to the invention. The subsequent step for washing the perovskite particles is therefore not necessary but, if desired, can be carried out. A suitable wash liquid is, for example, ethanol.

Furthermore, there is virtually no doping at metallic lattice sites by foreign substances, for example by Na⁺, or oxidic lattice, for example by carbonate.

Advantageously, the method according to the invention also permits the simple production of complicated mixed perovskites comprising a plurality of metals A and/or B, which are particularly interesting for technological applications.

By means of the methods according to the invention, the high yield of the perovskite particles produced can also be achieved. For example, yields of >about 50%, preferably >about 70%, more preferably >about 80% and most preferably >about 90% can be achieved.

The present invention furthermore relates to perovskite particles of the formula ABO₃, wherein A is a metal of low valency and B is a metal of higher valency, which are obtainable by the method according to the invention. The perovskite particles according to the invention preferably have a particle size of 2-40 nm, more preferably of 5-25 nm and most preferably of 5-10 nm, depending on the type of perovskite.

In addition, the perovskite particles according to the invention advantageously have high homogeneity with regard to the particle size, shape and crystallinity. With regard to the particle size, high homogeneity in the context of the present invention means that the standard Gaussian distribution is less than 30%, preferably less than 25%, more preferably less than 20%.

Thus, the use of the particles according to the invention has major advantages in comparison with conventional particles in many applications, for example in the production of thin layers or ceramics.

The perovskite particles according to the invention may be any desired mixed oxides of the formula ABO₃; the perovskite particles are preferably barium titanate, strontium titanate, lithium niobate or barium zirconate particles.

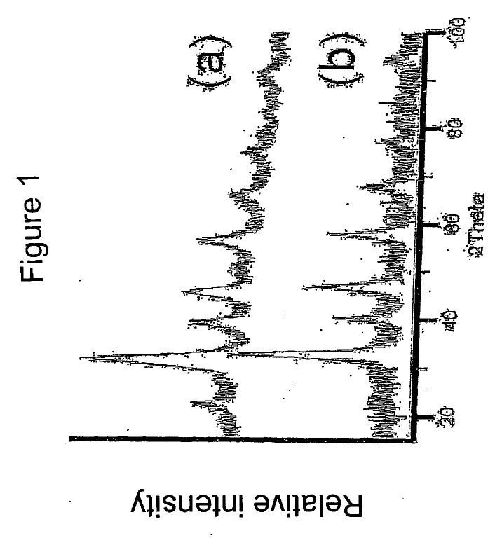

The subject matter of the present invention is furthermore illustrated by FIGS. 1-6 and the examples.

FIG. 1 shows the result of X-ray powder diffractometry of barium titanate (a) and strontium titanate (b) which was produced according to the present invention. All diffraction peaks can be assigned either to the barium titanate (a) or strontium titantate phase (b). There are no indications of other crystalline byproducts, such as, for example, barium carbonate. Owing to the size of the crystals in the nano range, all peaks are relatively broad.

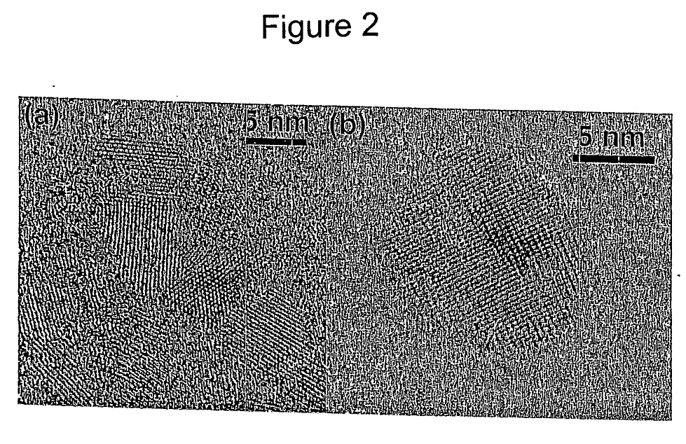

FIG. 2 shows transmission electron micrographs of barium titanate. FIG. 2(a) shows an overview image on a lower magnification. It can be seen that the particles are virtually spherical with diameters in the range of 5-10 nm. It can be seen that the particles are highly crystalline. FIG. 2(b) shows a particle having a diameter of 10 nm.

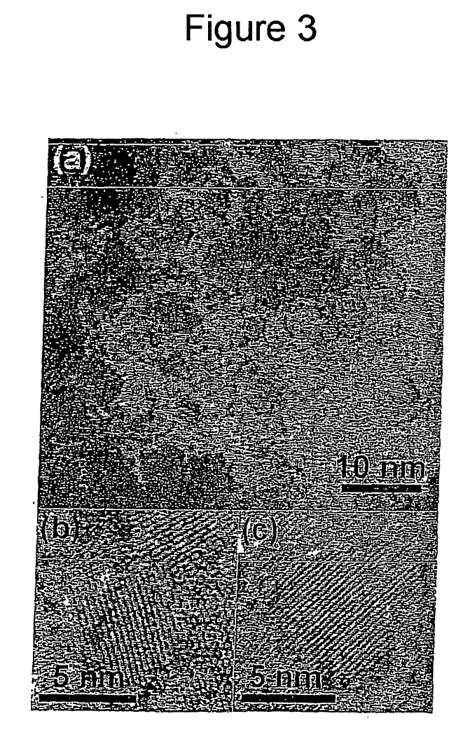

FIGS. 3(a)-(c) show transmission electron micrographs of an SrTiO₃ sample. It can be seen that the particles have diameters in the range of about 5-8 nm.

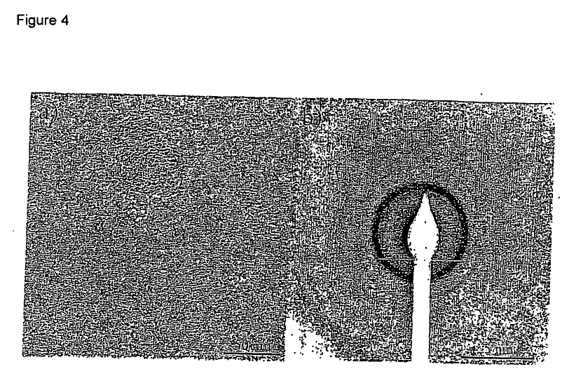

FIG. 4(a) shows the electron micrograph of a BaZrO₃ sample. FIG. 4(b) shows an electron diffraction picture of this sample.

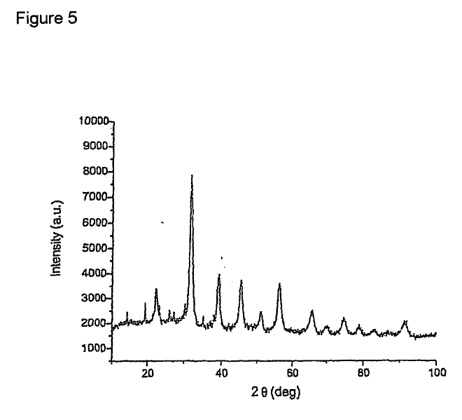

FIG. 5 shows the XRD diagram of a BaTiO₃ sample produced in acetone.

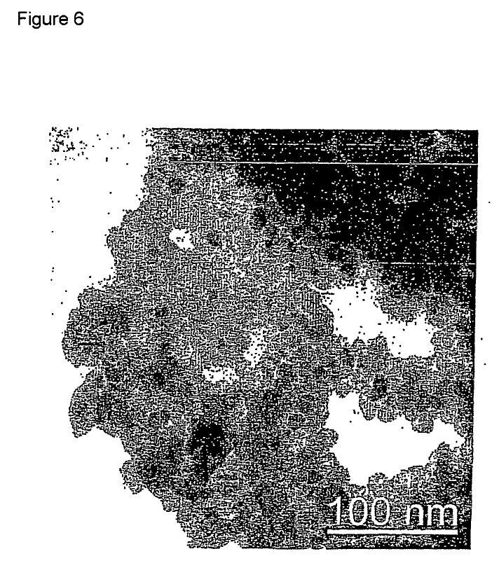

FIG. 6 shows a transmission electron micrograph of a BaTiO₃ sample produced in acetone.

### EXAMPLES

### Example 1

### Production of BaTiO₃ and SrTiO₃ in Benzyl Alcohol

3.57 g of metallic barium or strontium were dissolved in 25 ml of anhydrous benzyl alcohol at slightly elevated temperature (about 50° C.). Here, barium and strontium formed a slightly cloudy and yellowish solution in benzyl alcohol. Thereafter, 1 mole equivalent (based on barium or strontium) of titanium isopropoxide was added and the reaction mixture was transferred to an autoclave and heated in an oven for 48 h at 200° C. The resulting milky suspension was centrifuged (6000 rpm, 10 min) and the precipitate was thoroughly washed twice with ethanol and dried in the air at 60° C. The yield of the materials thus synthesized was about 90%.

### Example 2

### Production of LiNbO₃ in Benzyl Alcohol

35.2 mg of lithium were dissolved in 25 ml of benzyl alcohol at about 80° C. After addition of 1 mole equivalent of Nb(OEt)s, heating was effected in an autoclave for 48 h at 220° C. The white precipitate obtained was separated off by centrifuging, washed with ethanol and dried in the air at 60° C. Nanoparticles of LiNbO₃ having a diameter of 20±4 nm were formed.

### Example 3

### Production of BaZrO₃ in Benzyl Alcohol

3.6 mmol of metallic barium were dissolved in 25 ml of benzyl alcohol by gentle heating to about 50° C. After addition of one mole equivalent of zirconium isopropoxide and isopropanol (Zr(OiPr)₄.i-PrOH), the reaction mixture was heated in an autoclave to 200° C. for 3 days and then to 220° C. for a further 3 days. The precipitate obtained was separated off by centrifuging, washed with ethanol and diethyl ether and dried at room temperature.

Electron micrographs show that the particles have a size of 2-3 nm and form worm-like agglomerates (FIG. 4(a)). It was confirmed by electron diffraction that these are BaZrO₃ (FIG. 4(b)).

### Example 4

### Production of BaTiO₃ in Acetone

275 mg of metallic barium were reacted with 20 ml of acetone. A milky cloudy reaction mixture formed within a few minutes. After about one hour, 569 mg of Ti(OiPr)₄ were added (Ba:Ti molar ratio 1:1). The mixture was introduced into an autoclave and heated in an oven for 3 days at 130° C. The product obtained was filtered off, washed three times with chloroform and dried at room temperature.

The powder diffractogram shows the pattern characteristic of BaTiO₃ (FIG. 5). Small signals at 20=14.1 and 19.4° indicate traces of Ba(OH)₂. Transmission electron micrographs show nanoparticles of the order of magnitude of 10-20 nm (FIG. 6).

An advantage of the acetone method is the low reaction temperature in comparison with the benzyl alcohol process and the possibility of obtaining somewhat larger particles. In addition to acetone, for example acetophenone or benzaldehyde is also suitable as a solvent.

1. A method for producing perovskite particles of the formula ABO₃, wherein A is a metal of lower valency or a mixture of metals of lower valency and B is a metal of high valency or a mixture of metals of higher valency, characterized by the steps
(a) dissolution of the first metal or of the mixture of metals A in an anhydrous solvent or solvent mixture and
(b) reaction of the solution from (a) with an alkoxide of the second metal or of the mixture of metals B of the formula B(OR)ₓ and/or B(OR)ₓ₋₂, wherein x is the valency of the metal B and R is a linear or branched alkyl radical having 1 to 30 carbon atoms.

2. The method as claimed in claim 1, wherein the metal A is selected from the group consisting of alkali metals, alkaline earth metals and transition elements.

3. The method as claimed in claim 2, wherein the metal A is selected from the group consisting of the monovalent or divalent metals.

4. The method as claimed in claim 3, wherein the metal A is selected from the group consisting of strontium and barium.

5. The method as claimed in claim 1, wherein the metal B is selected from the group consisting of transition elements and metals of groups III and IV.

6. The method as claimed in claim 1, wherein the metal B is selected from the group consisting of the tetravalent or pentavalent metals.

7. The method as claimed in claim 6, wherein the metal B is titanium.

8. The method as claimed in claim 1, wherein the solvent is selected from alcohols, ketones, aldehydes and mixtures thereof.

9. The method as claimed in claim 8, wherein an alcohol or a mixture of an alcohol with a ketone and/or aldehyde is used as the solvent.

10. The method as claimed in claim 1, wherein the alcohol is sterically stabilizing alcohol.

11. The method as claimed in claim 10, wherein the alcohol is benzyl alcohol.

12. The method as claimed in claim 1, wherein the metal alkoxide in step (b) is titanium isopropoxide.

13. The method as claimed in claim 1, wherein step (b) is carried out at a temperature of from 190 to 220° C.

14. The method as claimed in claim 1, wherein, in step (b), a 10-100-fold excess of the solvent is present.

15. The method as claimed in claim 1, wherein the perovskite particles obtained after step (b) have a mean size of 5-10 nm.
